(19) United States
(12) Patent Application Publication
(10) Pub. No.: US 2019/0302900 A1
(43) Pub. Date: Oct. 3, 2019

(54) DISPLAY DEVICE

(71) Applicant: E Ink Holdings Inc., HSINCHU (TW)

(72) Inventors: Cheng-Hsien LIN, HSINCHU (TW); Hsin-Tao HUANG, HSINCHU (TW)

(21) Appl. No.: 16/361,198

(22) Filed: Mar. 21, 2019

(30) Foreign Application Priority Data
Apr. 3, 2018 (TW) 107111938

(51) Int. Cl. G06F 3/03; G06F 3/0354; G06F 3/041

(52) U.S. Cl. CPC G06F 3/0317; G06F 3/0412; G06F 3/03542

(57) ABSTRACT

A display device includes a reflective display panel, a surface layer and an optically encoded pattern. The surface layer is disposed over the reflective display panel. The optically encoded pattern has a plurality of optical codes respectively corresponding to a plurality of positions of the reflective display panel, and the optically encoded pattern is displayed by the reflective display panel or disposed between the reflective display panel and the surface layer.

### CROSS-REFERENCE TO RELATED APPLICATION

This application claims priority to Taiwan Application Serial Number 107111938, filed Apr. 3, 2018, which is herein incorporated by reference.

### BACKGROUND

### Field of Invention

The present disclosure relates to a display device, and more particularly to a display device applicable to optical pen identification technology.

### Description of Related Art

The current mainstream technology is electromagnetic pen or active capacitive pen identification technology. However, electronic circuits are required for pens and panels that use such technology. In addition, the panel has problems such as parasitic capacitance and driving noise interference, thereby the capacitive pen being unsuitable for use in a thin display.

### SUMMARY

A purpose of the present disclosure is to provide a display device applicable to optical pen identification technology. The display device includes a reflective display panel, a surface layer and an optically encoded pattern, and the optically encoded pattern is displayed by the reflective display panel or disposed between the reflective display panel and the surface layer. As such, an optical pen can be used to read optical codes of the display device to identify positions of the optical pen, and position information is then input to the reflective display panel to display handwriting to achieve a display function of pen writing.

The present disclosure provides a display device includes a reflective display panel, a surface layer and an optically encoded pattern. The surface layer is disposed over the reflective display panel. The optically encoded pattern has a plurality of optical codes respectively corresponding to a plurality of positions of the reflective display panel, and the optically encoded pattern is displayed by the reflective display panel or disposed between the reflective display panel and the surface layer.

According to some embodiments of the present disclosure, the display device further includes a touch panel disposed between the reflective display panel and the surface layer.

According to some embodiments of the present disclosure, the optically encoded pattern is in contact with a bottom surface of the surface layer, a top surface of the reflective display panel, or a top surface of the touch panel.

According to some embodiments of the present disclosure, the display device further includes a front light module disposed between the reflective display panel and the touch panel, or between the touch panel and the surface layer.

According to some embodiments of the present disclosure, the front light module is able to provide non-visible light.

According to some embodiments of the present disclosure, the non-visible light is infrared light or ultraviolet light.

According to some embodiments of the present disclosure, the optical codes are configured to be read by an optical pen and converted into position information, and the reflective display panel is configured to display the position information.

According to some embodiments of the present disclosure, the reflective display panel includes a front plane laminate (FPL) and a protective layer disposed over the front plane laminate, and the optically encoded pattern is disposed over and in contact with the protective layer, or disposed between the protective layer and the front plane laminate.

According to some embodiments of the present disclosure, the display device further includes an optically-clear adhesive disposed between the reflective display panel and the surface layer.

According to some embodiments of the present disclosure, the surface layer includes a cover lens, an anti-glare (AG) layer, a hard coating (HC) layer or an anti-reflection (AR) layer.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic cross-sectional view of a display device and an optical pen according to some embodiments of the present disclosure;

FIG. 2 is a schematic view of a display device, an optical pen and a host according to some embodiments of the present disclosure;

FIG. 3 is a schematic cross-sectional view of a display device and an optical pen according to some embodiments of the present disclosure;

FIG. 4 is a schematic cross-sectional view of a display device and an optical pen according to some embodiments of the present disclosure;

FIG. 5 is a schematic cross-sectional view of a display device and an optical pen according to some embodiments of the present disclosure;

FIG. 6 is a schematic cross-sectional view of a display device and an optical pen according to some embodiments of the present disclosure; and

FIG. 7 is a schematic cross-sectional view of a display device and an optical pen according to some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “over” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As mentioned above, the current mainstream electromagnetic pen or active capacitive pen identification technology still has some shortcomings. Accordingly, the present invention provides a display device applicable to optical pen identification technology. The display device includes a reflective display panel, a surface layer and an optically encoded pattern, and the optically encoded pattern is displayed by the reflective display panel or disposed between the reflective display panel and the surface layer. As such, an optical pen can be used to read optical codes of the display device to identify positions of the optical pen, and position information is then input to the reflective display panel to display handwriting to achieve a display function of pen writing. Several embodiments of the display device will be described in detail below.

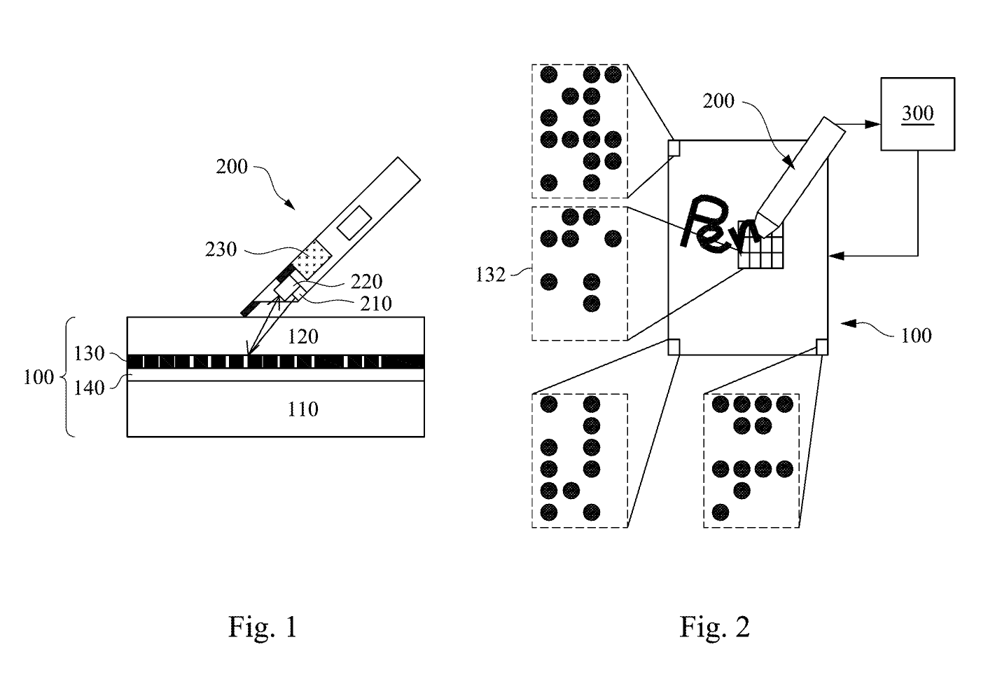

FIG. 1 is a schematic cross-sectional view of a display device 100 and an optical pen 200 according to some embodiments of the present disclosure. As shown in FIG. 1, the display device 100 includes a reflective display panel 110, a surface layer 120 and an optically encoded pattern 130.

In some embodiments, the reflective display panel 110 may be an electrophoretic display (EPD), a liquid crystal display (LCD), an electro wetting display (EWD), but not limited thereto. Taking the electrophoretic display as an example, the reflective display panel 110 may include a plurality of microcapsules. Each microcapsule has a plurality of light-colored charged particles and a plurality of dark-colored charged particles therein. The light-colored charged particles and the dark-colored charged particles have different charges. For example, the light-colored charged particles can be positively charged, and the dark-colored charged particles can be negatively charged. As such, the positions of the light-colored charged particles and those of the dark-colored charged particles in each microcapsule can be controlled by electric field to present a gray-scale pattern. That is, the reflective display panel 110 may be a grayscale display panel. In some embodiments, the reflective display panel 110 includes a color filter (not shown) therein. In other words, the reflective display panel 110 may be a color display panel.

The surface layer 120 is disposed over the reflective display panel 110. The surface layer 120 may be a cover lens, an anti-glare (AG) layer, a hard coating (HC) layer or an anti-reflection (AR) layer, but not limited thereto. The surface layer 120 may enhance optical quality or strength of the display device 100. The kind of the surface layer 120 may be appropriately selected according to requirements.

In a top view, the optically encoded pattern 130 has a plurality of optical codes respectively corresponding to a plurality of positions of the reflective display panel 110. The optical codes are configured to be read by the optical pen 200 and converted into position information. In some embodiments, the optical code is constituted by a plurality of dots (e.g., black dots or white dots) arranged in a particular pattern (e.g., the optical code 132 shown in FIG. 2), and the dots may have an effect of absorbing or reflecting non-visible light. In some embodiments, the dots have the effect of absorbing non-visible light.

In some embodiments, as shown in FIG. 1, the optical pen 200 includes a non-visible light source 210 and an optical sensing element 220. In some embodiments, the non-visible light source 210 is infrared light or ultraviolet light. In some embodiments, the optical sensing element 220 includes a charge coupled device (CCD) or a complementary metal-oxide semiconductor (CMOS), but not limited thereto. In some embodiments, the optical pen 200 further includes a pressure sensing element 230 to sense pressure of the pen tip in contact with the surface layer 120.

The principle of displaying pen writing is briefly described as follows. When light of the non-visible light source 210 of the optical pen 200 reaches the optical code, the light is absorbed or reflected by the optical code to produce a contrast image. The contrast image is captured by the optical sensing element 220 and interpreted to obtain position information. The position information is then input to the reflective display panel 110 for displaying to achieve the display function of the pen writing.

FIG. 2 is a schematic view of a display device 100, an optical pen 200 and a host 300 according to some embodiments of the present disclosure. As shown in FIGS. 1 and 2, when the optical pen 200 moves over the surface layer 120, a plurality of specific optical codes 132 can be read to obtain a series of position information. The position information can be then input to the reflective display panel 110 to display handwriting to achieve the display function of the pen writing. In some embodiments, the position information obtained by the optical pen 200 can be transmitted to the host 300 through a wired or wireless connection (e.g., bluetooth), and the position information is then input to the reflective display panel 110 through the host 300 to display the handwriting.

It is noted that the optically encoded pattern 130 may be displayed by the reflective display panel 110 or be disposed between the reflective display panel 110 and the surface layer 120. In some embodiments, as shown in FIG. 1, the optically encoded pattern 130 is a pattern layer disposed between the reflective display panel 110 and the surface layer 120 and in contact with a bottom surface of the surface layer 120. In some embodiments, the pattern layer is a substrate having optical codes. The substrate may be, for example, a transparent plastic substrate such as polyethylene terephthalate (PET), polycarbonate (PC) or poly methylmethacrylate (PMMA), but not limited thereto. In some embodiments, the optical codes are formed on the substrate through a printing process. In some embodiments, the size of the smallest image unit of the optical code is less than or equal to 0.09 mm. In some embodiments, the size of the smallest image unit of the optical code is greater than or equal to half the wavelength of the sensing light (e.g., infrared or ultraviolet light). In some embodiments, the size of the smallest image unit of the optical code is greater than or equal to 0.02 mm.

In some embodiments, the display device 100 further includes an optically-clear adhesive (OCA) 140 disposed between the reflective display panel 110 and the surface layer 120. In some embodiments, as shown in FIG. 1, the optically-clear adhesive 140 is disposed between the reflective display panel 110 and the optically encoded pattern 130.

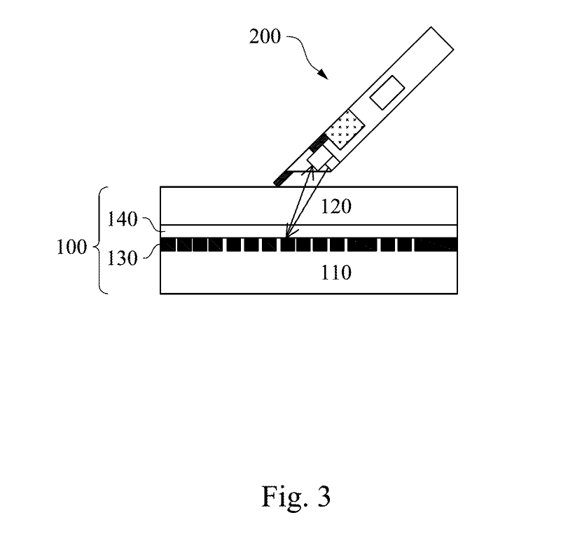

FIG. 3 is a schematic cross-sectional view of a display device 100 and an optical pen 200 according to some embodiments of the present disclosure. As shown in FIG. 3, in some embodiments, the optically encoded pattern 130 is displayed by the reflective display panel 110. In detail, the reflective display panel 110 has a plurality of sub-pixel regions. The optically encoded pattern 130 (i.e., a plurality of optical codes) may be presented by controlling the display of the sub-pixel regions. In some embodiments, as shown in FIG. 3, the optically-clear adhesive 140 is disposed between the reflective display panel 110 and the surface layer 120.

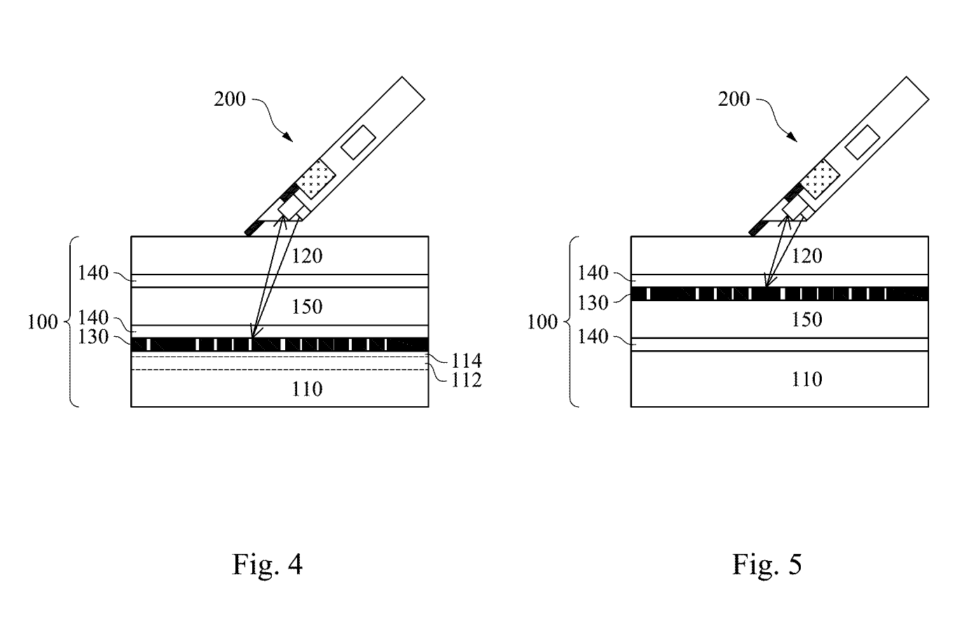

FIG. 4 is a schematic cross-sectional view of a display device 100 and an optical pen 200 according to some embodiments of the present disclosure. The difference between FIG. 4 and FIG. 1 is that the display device 100 of FIG. 4 further includes a touch panel 150. The touch panel 150 is disposed between the reflective display panel 110 and the surface layer 120.

Another difference between FIG. 4 and FIG. 1 is that the optically encoded pattern 130 of FIG. 4 is in contact with a top surface of the reflective display panel 110. In some embodiments, the reflective display panel 110 includes a front plane laminate (FPL) 112 and a protective layer 114, and the protective layer 114 is disposed over the front plane laminate 112. In some embodiments, as shown in FIG. 4, the optically encoded pattern 130 is disposed over and in contact with the protective layer 114, but not limited thereto. In other embodiments, the optically encoded pattern may be disposed between the protective layer 114 and the front plane laminate 112.

FIG. 5 is a schematic cross-sectional view of a display device 100 and an optical pen 200 according to some embodiments of the present disclosure. The difference between FIG. 5 and FIG. 4 is that the optically encoded pattern 130 of FIG. 5 is disposed between the touch panel 150 and the surface layer 120 and in contact with a top surface of the touch panel 150.

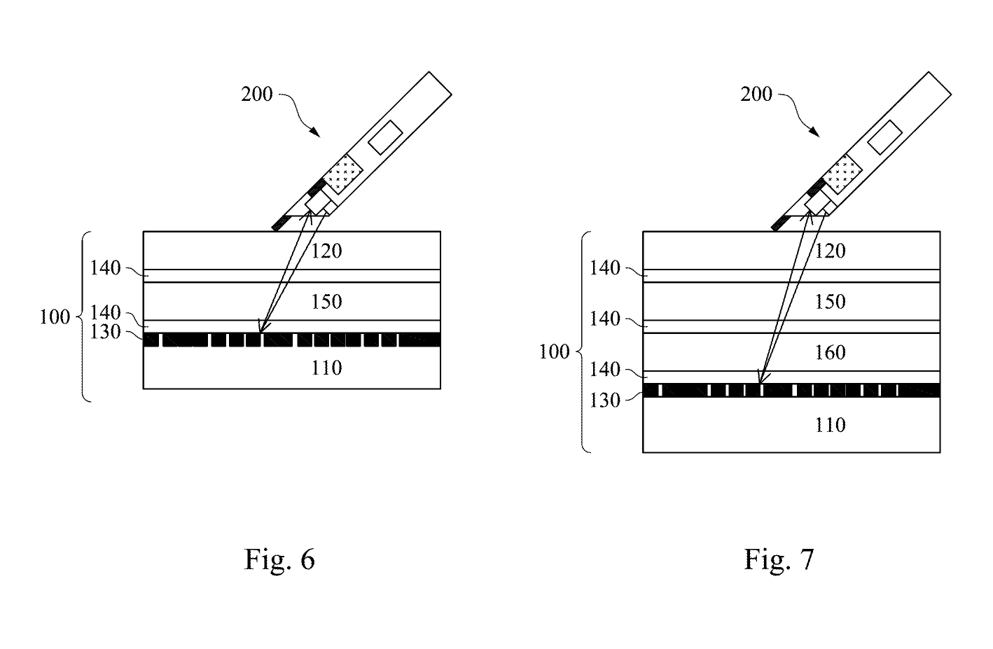

FIG. 6 is a schematic cross-sectional view of a display device 100 and an optical pen 200 according to some embodiments of the present disclosure. The difference between FIG. 6 and FIG. 4 is that the optically encoded pattern 130 of FIG. 6 is displayed by the reflective display panel 110.

FIG. 7 is a schematic cross-sectional view of a display device 100 and an optical pen 200 according to some embodiments of the present disclosure. The difference between FIG. 7 and FIG. 4 is that the display device 100 of FIG. 7 further includes a front light module 160. In some embodiments, as shown in FIG. 7, the front light module 160 is disposed between the reflective display panel 110 and the touch panel 150, but not limited thereto. In other embodiments, the position of the front light module 160 and that of the touch panel 150 shown in FIG. 7 may be exchanged so that the front light module 160 is disposed between the touch panel 150 and the surface layer 120.

In some embodiments, before using the display function of the pen writing of the display device 100 shown in FIG. 7, that is, before reading the optical codes using the optical pen 200, the light source (e.g., visible light source) of the front light module 160 may be turned off to prevent visible light from interfering with the identification of the optical pen 200.

In some embodiments, as shown in FIG. 7, the front light module 160 can provide non-visible light, such as infrared light or ultraviolet light. As such, before using the display function of the pen writing of the display device 100 shown in FIG. 7, that is, before reading the optical code using the optical pen 200, the front light module 160 may be turned on to provide non-visible light for the optical pen 200 to perform optical identification. As a result, the non-visible light source 210 may not be provided in the optical pen 200.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A display device, comprising:
a reflective display panel;
a surface layer disposed over the reflective display panel; and
an optically encoded pattern having a plurality of optical codes respectively corresponding to a plurality of positions of the reflective display panel, and the optically encoded pattern displayed by the reflective display panel or disposed between the reflective display panel and the surface layer.

2. The display device of claim 1, further comprising:
a touch panel disposed between the reflective display panel and the surface layer.

3. The display device of claim 2, wherein the optically encoded pattern is in contact with a bottom surface of the surface layer, a top surface of the reflective display panel, or a top surface of the touch panel.

4. The display device of claim 2, further comprising:
a front light module disposed between the reflective display panel and the touch panel, or between the touch panel and the surface layer.

5. The display device of claim 4, wherein the front light module is able to provide non-visible light.

6. The display device of claim 5, wherein the non-visible light is infrared light or ultraviolet light.

7. The display device of claim 1, wherein the optical codes are configured to be read by an optical pen and converted into position information, and the reflective display panel is configured to display the position information.

8. The display device of claim 1, wherein the reflective display panel comprises a front plane laminate (FPL) and a protective layer disposed over the front plane laminate, and the optically encoded pattern is disposed over and in contact with the protective layer, or disposed between the protective layer and the front plane laminate.

9. The display device of claim 1, further comprising:
an optically-clear adhesive disposed between the reflective display panel and the surface layer.

10. The display device of claim 1, wherein the surface layer comprises a cover lens, an anti-glare (AG) layer, a hard coating (HC) layer or an anti-reflection (AR) layer.
